(19) United States
(12) Patent Application Publication
(10) Pub. No.: US 2026/0350706 A1
(43) Pub. Date: Nov. 5, 2026

(54) System and Method for Personalized, Multi-User Credit Advising, Debt Analysis, and Financial GrowthOptimization

(71) Applicant: Reginald Bernard Lowe, JR., Grantville, GA (US)

(72) Inventor: Reginald Bernard Lowe, JR., Grantville, GA (US)

(21) Appl. No.: 19/196,782

(22) Filed: May 2, 2025

(51) Int. Cl. G06Q 40/06; G06Q 40/03

(52) U.S. Cl. CPC G06Q 40/06; G06Q 40/03

(57) ABSTRACT

Disclosed herein is a comprehensive digital system and method for personalized credit advising, debt analysis, and financial growth optimization. It integrates real-time analysis of credit card and loan data, tracking of payment due dates and statement cycles, and calculates optimal utilization thresholds. The system delivers personalized financial product recommendations, monitors debt-to-income ratios, and provides alerts for mortgage pre-approval readiness. Designed for individual and multi-user accounts (family or couple), it supports collaborative credit strategies and features a downloadable “Financial Resume” for presenting financial credibility to lenders. The platform also includes a tradeline marketplace and connects users to vetted legal professionals for assistance in disputes, FCRA claims, or debt defense. This system redefines traditional credit repair by automating personalized advice and combining financial education with strategic planning, empowering users to build sustainable credit and generational wealth.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

The present invention relates to the field of financial technology and credit advising systems. Specifically, it involves a software-based platform for real-time, personalized, and collaborative credit advising and debt management. The system uses user financial profiles, credit card behavior, and predictive analytics to educate, optimize credit usage, and empower users. It supports multiple account types including individuals, couples, and families, and integrates tools for mortgage pre-qualification, tradeline marketplaces, and legal support in financial disputes.

### Description of the Related Art

The general background of this invention is rooted in the increasing demand for effective credit-building and financial empowerment tools, especially among individuals with limited access to traditional banking services. In many parts of the world, particularly in the United States, a strong credit profile is essential for securing loans, renting homes, obtaining insurance, and even gaining employment. Yet, millions of consumers are either unscored or under-scored due to lack of credit history, inconsistent income reporting, or financial hardship. The conventional credit education landscape is fragmented, offering either static content or reactive monitoring solutions that do not proactively guide users toward real improvement. As a result, consumers are often left navigating a complex system without the necessary tools or insights.

The importance of solving this challenge is underscored by growing economic inequality and the rising cost of borrowing. According to the Consumer Financial Protection Bureau (CFPB), over 45 million Americans are “credit invisible” or lack sufficient credit history to be scored by major credit bureaus. Furthermore, studies by Experian show that a one-point increase in credit score can translate into hundreds or thousands of dollars in borrowing cost savings annually. Given the systemic nature of credit scoring, improving one's credit can be a life-changing financial lever. Financial inclusion, therefore, is not just a social responsibility—it is also a significant economic opportunity. Building smarter, scalable solutions to empower individuals with tools to take control of their financial narrative is both necessary and impactful.

Innovation in this field has seen contributions from fintech platforms such as Credit Karma, Self, and Experian Boost. Credit Karma offers users free credit monitoring and basic insights but does not provide dynamic, goal-based planning. Self helps users build credit through secured credit-builder loans, while Experian Boost allows users to add utility and streaming bill payments to their credit files. However, these platforms tend to be narrowly focused—either on monitoring, a specific tradeline product, or a single credit bureau. Most existing tools are reactive, presenting users with past behavior data and generalized advice rather than simulating future outcomes or providing collaborative planning. The innovation gap lies in connecting analysis with predictive intelligence and proactive guidance.

By looking at prior art, multiple innovations can be seen in a similar domain. For instance, a U.S. Pat. No. 8,719,132B1 relates to a Financial Management System and Method with Debt Management. This patent discloses a financial management system that integrates debt management functionalities. It allows users to input various debt sources, such as auto loans and credit card debts, and provides a consolidated view through graphical representations like pie charts. The system calculates periodic payment amounts and timelines for debt payoff, offering users a structured approach to manage their debts. While it provides a comprehensive debt overview, it lacks personalized credit advising and multi-user collaboration features.

### Google Patents

A U.S. Pat. No. 11,715,474B2 relates to systems and methods for pervasive advisor for major expenditures. This patent presents a system that offers users dynamic feedback on their creditworthiness, particularly concerning major expenditures. By analyzing internal credit scores and financial behaviors, the system can pre-qualify users for loans without external credit checks. It provides immediate feedback on actions that positively impact credit scores, enhancing user engagement. However, it primarily focuses on individual users and lacks features like family account setups or legal dispute support. patents.justia.com

A U.S. Pat. No. 7,844,518B1 relates to method and apparatus for managing credit limits. This invention relates to a system that manages multiple credit lines by adjusting credit limits based on usage history. It reallocates credit among various accounts to optimize credit utilization. The system operates with minimal human intervention, allowing for efficient credit management. Despite its automation capabilities, it does not offer personalized advising or collaborative financial planning features.

A U.S. Pat. No. 10,963,960B2 relates to computer system for automatic credit allocation of a shared line of credit. This patent describes a system that uses machine learning to allocate credit within a shared line of credit among multiple users. It is particularly useful for organizations or families managing a collective credit resource. The system predicts credit needs and reallocates credit accordingly. While it addresses multi-user scenarios, it focuses on credit allocation rather than comprehensive credit advising or debt analysis.

A U.S. Pat. No. 10,5043,85B2 relates to systems and methods for providing credit coaching. This patent introduces a credit coaching system that evaluates a user's financial behavior to recommend upgraded financial or insurance products. It considers factors like credit score improvements, timely payments, and completed credit courses. The system offers personalized product suggestions, enhancing the user's financial portfolio. However, it does not encompass features like multi-user collaboration, legal dispute assistance, or a tradeline marketplace

Despite these advancements, users still face notable shortcomings. Many platforms do not account for multi-person households or shared financial planning. They lack interactivity, adaptability, and personalized feedback beyond generic suggestions. Tools are often not bilingual, not trauma-informed, and rarely inclusive of legal recourse or human support for complex credit challenges such as identity theft or wrongful collections. Moreover, many platforms fail to integrate educational content that is context-specific and immediately actionable. This leaves users informed but immobilized—knowing there is a problem, but unsure how to fix it or where to begin. As a result, financial literacy tools often see high drop-off rates and limited long-term engagement.

The invention addresses these gaps by providing a comprehensive, modular, and AI-powered credit building platform that evolves with the user. It uniquely combines predictive analytics, real-time coaching, collaborative dashboards, and legal empowerment tools into one ecosystem. The platform does not just inform—it plans, alerts, advises, and acts. With features like AI-based credit forecasting, personalized growth plans, pre-approval detection, and shared financial goal-setting for families, it becomes a dynamic partner in a user's financial journey. The system integrates credit education with guided action, offering both solo and multi-user experiences, thus acknowledging the social and cooperative nature of financial health.

This invention fulfills a critical market gap by transforming credit improvement into a proactive and collaborative process. It democratizes access to sophisticated credit modeling tools that were previously reserved for banks and institutions, repackaging them for end-users in an intuitive and supportive environment. It merges traditionally siloed services—such as financial planning, credit simulation, legal aid, and educational content—into one seamless application. In doing so, it meets the needs of underserved populations including immigrants, low-income families, and young adults, who are disproportionately affected by poor or nonexistent credit. The invention not only educates but also mobilizes users toward measurable outcomes, closing the loop between awareness and impact.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The present invention seeks to improve prior techniques and provide a personalized, multi-user credit advising, debt analysis, and financial growth optimization.

It is the objective of the invention to provide a personalized credit advising system that analyzes real-time financial data and offers customized strategies for credit improvement.

A further objective of the present invention is to simplify the credit-building process for individuals, couples, and families by providing a collaborative platform for managing and improving credit.

It is also an object of the invention to automate financial decision-making using AI-driven forecasts that help users understand and improve their future credit standing.

It is further the objective of the invention to facilitate proactive debt management through tools like debt-to-income tracking and payment reminders.

It is also the objective of the invention to integrate a tradeline marketplace within the platform to help users build or diversify credit profiles effectively.

The objective of the invention is to enable users to create a downloadable Financial Resume that reflects their creditworthiness for use in loan or rental applications.

It is also the objective of the invention to assist users in navigating the mortgage approval process with timely alerts and tailored recommendations.

It is further the objective of the invention to empower users legally by connecting them with vetted legal professionals for dispute resolution and FCRA support.

The invention aims to offer educational tools and modules that adapt to users'credit behavior and enhance financial literacy.

It is the objective of the invention to provide advertising opportunities for real estate and financial professionals within the platform, creating a revenue stream and value-added services for users.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 illustrates the Vertical Credit Optimization Model as per preferred embodiments of the invention.

FIG. 2 illustrates the Collaborative Flow Household and Partner Credit Model as per preferred embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The present invention relates to an intelligent and personalized digital credit-building and financial empowerment platform that addresses the fragmented nature of traditional credit advisory services. It centralizes and automates the core elements of credit analysis, forecasting, planning, and collaboration through a user-friendly interface. Unlike static credit education tools, this invention dynamically interacts with users' financial data to build a proactive and evolving plan. The key functionalities are driven by AI algorithms that analyze imported credit data, track payment behavior, model score trajectories, and optimize debt utilization in real time. This is not merely a credit monitoring solution; it is a predictive and prescriptive financial growth engine.

As per its preferred embodiments, the platform offers a guided, step-by-step user experience beginning with personalized onboarding. After account creation, users connect their credit and financial data, which the system parses to extract tradeline information, utilization patterns, payment history, and score factors. Once imported, an AI-driven forecasting model simulates potential outcomes based on behavioral adjustments—such as early payments, credit line increases, or payoff strategies. Users are then provided with a unique credit growth plan tailored to their goals, current financial posture, and credit improvement opportunities. The system also factors in key score-impacting elements like credit age, recent inquiries, and derogatory marks, presenting real-time strategies to mitigate weaknesses.

As per its further embodiments, the platform includes pre-approval intelligence tools that alert users when they become eligible for specific credit products, such as mortgages or personal loans. These alerts are based on rules configured by partner institutions or industry benchmarks, factoring in current score, income verification, and account history. Once eligible, users receive guided recommendations on steps to apply successfully. At the same time, the system automatically updates their financial resume—a professional, exportable profile that includes current score, utilization summaries, on-time payment ratios, and custom statements prepared for underwriters or landlords. This document becomes a verified, human-readable representation of the user's financial character.

As per its further embodiments, the invention is deeply focused on accessibility and legal empowerment. It offers a repository of legal templates for credit disputes, debt defense, and FCRA complaints. For more complex situations, it connects users with legal professionals within the platform who can assist in case reviews or escalate matters when needed. These services are targeted toward users historically underserved by legal systems, offering education, empowerment, and execution within the same ecosystem. This dimension transforms the product from a financial utility into a broader tool for economic justice and consumer advocacy.

As per its further embodiments, the invention also recognizes the shared nature of financial decision-making in many households. The platform allows couples or families to co-manage their financial progress through shared dashboards and linked goals. Authorized user strategies can be recommended and simulated, such as boosting a spouse's score by adding them to a high-limit card or jointly planning pay-down efforts for shared liabilities. This adds a layer of collective planning rarely seen in current financial tools, fostering transparency, education, and a culture of mutual financial responsibility.

As per its further embodiments, a tradeline marketplace is also embedded within the platform. Users can view and compare secured cards, credit-building loans, or partner tradeline services based on their profile. The system may recommend guaranteed approval products or seasonal offers that align with the user's current eligibility. By facilitating these connections, the invention shortens the time between diagnosis and solution—turning insights into actionable steps with real financial impact. This marketplace also supports affiliate monetization, enabling the platform to scale sustainably while adding real-world value to users.

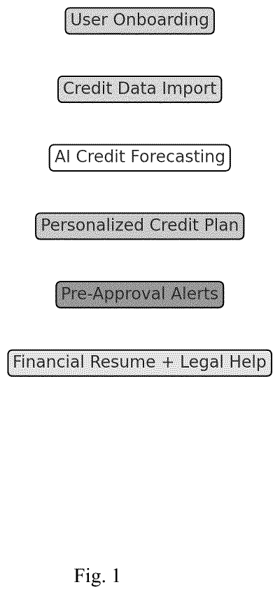

The invention can be further understood by the provided figures. The FIG. 1 illustrates the linear progression of an individual user through the platform's standard credit enhancement model. The journey begins with User Onboarding, where the user is guided through secure account creation and basic financial intake. Following this, Credit Data Import retrieves credit bureau data and financial account details using integrated APIs or uploaded files. This data is cleansed, categorized, and standardized by the platform. Then, AI Credit Forecasting uses this data to simulate various financial decisions and predict how they might impact the user's credit over time. This feature utilizes machine learning models trained on historical financial behavior and outcomes.

Next, the user is provided with a Personalized Credit Plan, which outlines step-by-step actions to improve their score—such as strategic payment reminders, recommended utilization thresholds, or consolidation tips. If the system detects readiness, it then triggers Pre-Approval Alerts, notifying users of pre-qualified offers from lenders or mortgage partners. Finally, the process culminates with the generation of a Financial Resume+Legal Help resource. This document summarizes the user's progress and current standing, while also offering access to legal services for dispute resolution or consumer protection. This diagram showcases the individualized optimization sequence that guides solo users from assessment to credit maturity.

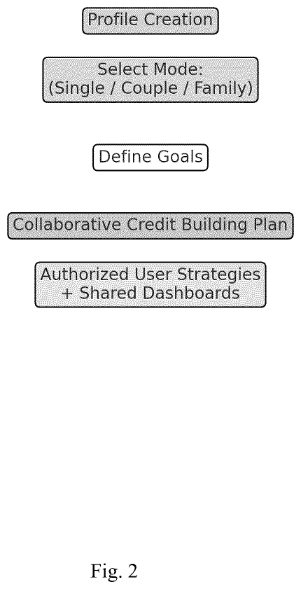

FIG. 2 represents a collaborative model geared toward couples and families who wish to build or repair credit together. It begins with Profile Creation, much like FIG. 1, but quickly branches into a more tailored experience. Users are prompted to Select Mode—Single, Couple, or Family. This selection informs the logic of the platform, allowing the system to track financial interactions and goals as shared or individual, depending on the configuration. This stage introduces linked profiles and shared access to credit plans, fostering coordinated effort and mutual accountability.

Following this, users are prompted to Define Goals—such as qualifying for a mortgage within 12 months or reducing total utilization by 30%. These goals become anchor points that drive the Collaborative Credit Building Plan, which includes joint payoff strategies, shared alerts, and behavior tracking across profiles. The system then layers on features like Authorized User Strategies+Shared Dashboards, enabling users to track progress in tandem. This model promotes financial transparency, improves household literacy, and accelerates goal achievement through a cooperative structure. FIG. 2 highlights how the invention supports financial ecosystems beyond the individual, delivering tools specifically built for collaborative financial growth.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

We claim:

1. A method for advising a user on credit management comprising: importing credit card and loan data; analyzing current usage; calculating 5% and 30% utilization thresholds; identifying statement and due dates; generating payment reminders; recommending financial products; calculating debt-to-income ratios; and generating personalized credit advising plans.
The method of claim 1, wherein alerts are sent to users at strategic times to improve credit scores based on statement cycles and utilization thresholds.
The method of claim 1, further comprising recommending alternative third-party financial products when primary bank recommendations are not feasible.
The method of claim 1, further comprising generating a downloadable Financial Resume summarizing the user's financial and credit milestones.
The method of claim 1, further comprising providing alerts to users when they are likely to qualify for mortgage pre-approval based on credit readiness and debt-to-income ratio analysis.
The method of claim 1, wherein the advising system includes predictive AI-based forecasting of future credit scores based on current behavior trends.
The method of claim 1, wherein users are educated through customized learning modules tailored to their financial behavior and milestones.
The method of claim 1, wherein legal referral options are provided for dispute resolution and credit reporting defense under FCRA and FDCPA guidelines.

2. A system comprising a mobile app and/or web-based platform implementing the method via user dashboards, financial calculators, educational tutorials, and monitoring tools.
The system of claim 2, wherein multiple users under a single family account can collaboratively manage credit growth via a shared dashboard.
The system of claim 2, wherein users receive real-time alerts about changes in credit eligibility and payment performance.
The system of claim 2, wherein the platform supports a tradeline marketplace with offerings for both beginner and seasoned credit accounts.
The system of claim 2, wherein real estate professionals and mortgage brokers may advertise services and pay partner dues through the platform.
The system of claim 2, wherein AI tools assist in forecasting credit trajectory and optimizing application timing.
The system of claim 2, wherein users can access downloadable templates for legal correspondence regarding credit disputes.

3. A method for generating and managing a multi-user credit profile environment for household-based financial strategy planning and credit optimization.
The method of claim 3, wherein profiles are classified as Single, Couple, or Family and recommendations are made collaboratively.
The method of claim 3, wherein the system suggests authorized user additions to optimize collective credit scores.
The method of claim 3, wherein milestone-based goals and financial growth achievements are tracked across all profiles.
The method of claim 3, wherein financial resume outputs reflect collective household credit performance.
The method of claim 3, wherein shared alerts inform all linked users of critical financial events and improvement strategies.
The method of claim 3, wherein profile access and permissions are role-based to protect financial privacy and control.
The method of claim 3, wherein the system recommends credit strategies based on collective household DTI, payment history, and utilization.
